(19) United States
(12) Patent Application Publication
(10) Pub. No.: US 2017/0116892 A1
(43) Pub. Date: Apr. 27, 2017

(54) SIGNAGE SYSTEM

(71) Applicant: Clamp Swing Pricing Company, Oakland, CA (US)

(72) Inventor: Benjamin Garfinkle, Piedmont, CA (US)

(21) Appl. No.: 14/924,411

(22) Filed: Oct. 27, 2015

(51) Int. Cl. G09F 7/18; G09F 15/00; G09F 23/00; G09F 7/08

(52) U.S. Cl. CPC G09F 7/18; G09F 7/08; G09F 15/0018; G09F 23/00; G09F 2007/1847; G09F 2007/1856

(57) ABSTRACT

A system for providing signage associated with a shelf. The shelf has a forward facing edge and channel lips along this edge. A clip having a forward facing support surface, a first leg extending from the forward facing support surface toward the forward facing edge having an upturned edge for capture by the channel lips and a second leg extending from the forward facing support surface toward the forward facing edge having a downward edge for capture by the channel lips, the forward facing support surface being configured to support signage related to goods on the shelf. The first and second legs of the clip are of different lengths such that when the clip is supported by the channel lips, the forward facing support surface and associated signage are diagonally oriented with respect to the shelf.

### TECHNICAL FIELD

The present invention is related to a system for providing signage at the forward edge of a shelf being associated with goods on the shelf. The system includes a unique clip feature for orienting the forward face of the clip and supported signage diagonally from the shelf.

### BACKGROUND OF THE INVENTION

The vast majority of retailers display goods for purchase by consumers on shelving driven by their attempt to maximize product packing or density while displaying products in a manner that would encourage consumers to make positive purchasing decisions.

In turning to FIG. 1, shelf 10 is shown which is intended to extend horizontally or slanted downwardly, surface 11 being a support for consumer products with forward edge 12 supporting tag molding channel 13 Tag molding channel 13 can be used to receive signage frictionally captured or adhered by a pressure sensitive adhesive between upper and lower channel lips 14 and 15, respectively. However, there are instances where a merchant would find it desirable to associate more impactful signage with the goods or provide signage which contains more information than could conveniently be captured within tag molding channel 13.

As even the casual consumer is aware, shelving, such as that described above can be used singularly or in parallel rows within a wide span of heights, or in refrigerated cases supporting trays that slant downwardly. Signage which is carried by shelving or trays that are slanted downwardly can be difficult to read unless the consumer was to crouch down or bend over. Certainly when eye-grabbing messaging is supported by the subject signage, the impact of the message can be lost if it is not facing the consumer at the point of potential purchase.

It is thus an object of the present invention to provide signage which overcomes the limitations of the prior art as discussed above.

This and further objects to be more readily apparent when considering the following disclosure and appended claims

### SUMMARY OF THE INVENTION

A system for providing signage associated with a shelf, said system comprising a shelf, such shelf having a forward facing edge, a tag molding channel comprised of channel lips along said forward facing edge, a clip having a forward facing support surface, a first leg extending from said forward facing support surface toward said forward facing edge and having an upturned edge for capture by an upper channel lip and a second leg extending from said forward facing support surface toward said forward facing edge having a downward edge for capture by a lower channel lip, said forward facing support surface being configured to support signage related to goods being supported on said shelf, and wherein said first and second legs are of different lengths such that when said clip is supported by said tag molding channel, said forward facing support surface and associated signage are diagonally oriented with respect to said shelf

### BRIEF DESCRIPTION OF THE FIGURES

FIG. 1 is a perspective view of a typical merchandise shelf having a front facing tag molding feature.

FIG. 2 is a perspective view of a clip constituting a part of the present invention.

FIG. 3 is a perspective view of signage for use with the clip of FIG. 2.

FIG. 4 is a side view of the clip of FIG. 2 joined with the signage of FIG. 3 joined to the merchandise shelf of FIG. 1.

FIG. 5 is a plan view of secondary signage to be supported by the signage of FIG. 3 in order to obscure the joinder of the clip of FIG. 2 thereto

FIG. 6 is a perspective view of the signage of FIG. 3 as it is intended to be joined to the clip of FIG. 2

FIGS. 7A-7B are side views of the prior art in comparison to the present invention joined to merchandise shelves in two orientations

### DETAILED DESCRIPTION OF THE INVENTION

Novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration description only and are not intended as definitions of the limits of the invention. The various features of novelty which characterize the invention are recited with particularity in the claims.

There has been broadly outlined important features of the invention in the summary presented above. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention It is important therefore, that claims be regarded as including such equivalent constructions insofar as they do not depart from the spirit and scope of the present invention

Certain terminology and the derivations thereof may be used in the following description for convenience and reference only, and will not be limiting For example, words such as “upward,” “downward,” “left,” and “right” refer to directions in the drawings to which reference is made unless otherwise stated. Similar words such as “inward” and “outward” refer to directions toward and away from, respectively, the geometric center of a device or area and designated parts thereof. Reference in the singular tense include the plural and vice versa, unless otherwise noted

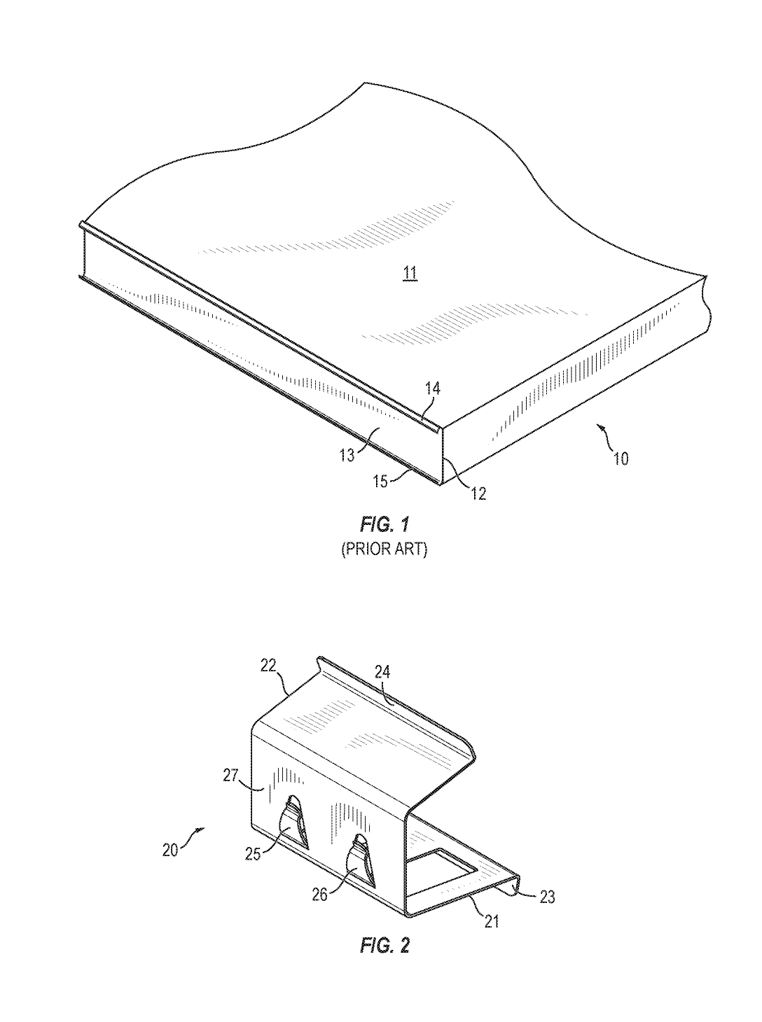

As noted, the present invention involves a system for providing signage associated with a shelf having a forward facing edge and a tag molding channel appended thereto FIG. 1 depicts shelf 10 having top surface 11 for the support of merchandise offered to consumers and a tag molding channel 13 having upper and lower channel lips 14 and 15, respectively. Typically, tag molding channel 13 is employed to receive inserts or labels which describe the goods, generally by name and price which appear just above the inserts. However, in order to achieve greater impact and provide more useful information to consumers than what would otherwise be the case, the present invention was conceived as more fully appreciated in reference to remaining FIGS. 2-7.

Turning to FIG. 2, clip 20 is shown Clip 20 is characterized as having forward facing support surface 27, first leg 22 extending from forward facing support surface 27 and having an upturned edge 24 for capture by upper channel lip 14 of tag molding channel 13 Clip 20 is also characterized as having second leg 21 extending from forward facing support surface 27 having a downward edge 23 for capture by lower channel lip 15 of tag molding channel 13.

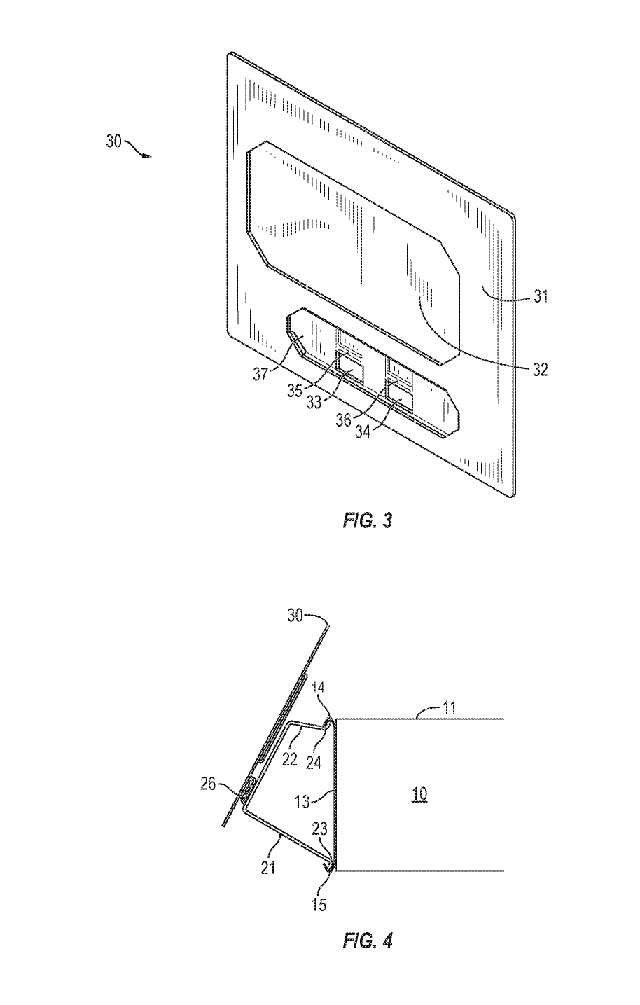

Forward facing support surface 27 of clip 20 is configured to support signage 30 (FIG. 3), signage 30 being related to goods being supported on surface 11 of shelf 10.

A feature of the present invention is to fabricate clip 20 by providing legs 21 and 22 of different lengths so that forward facing support surface 27 and associated signage 30 are diagonally oriented with respect to shelf 10 As a preferred embodiment, first leg 22 of clip 20 is shorter than second leg 21 of clip 20 such that support surface 27 and associated signage 30 are diagonally oriented upwardly with respect to shelf 10

In referring to FIG. 3, signage 30 is characterized as having face 31 which supports information that a consumer would generally need in making a purchasing decision as it pertains to merchandise stacked behind signage 30 on surface 11. For the sake of illustration, indented portion 32 is shown providing a region where such information could be received although signage 30 could assume many different and diverse configurations while remaining within the spirit and scope of the present invention

In referring to FIGS. 2, 3 and 4, the preferred method of joining clip 20 to signage 30 is illustrated. Specifically, at least one upwardly extending hook member is employed, in this case, two such hook members 25 and 26 are depicted These upwardly extending hook members are sized with respect to openings 33 and 34 such that signage 30 can simply be joined to clip 20 by passing upwardly extending hook members 25 and 26 through openings 33 and 34, respectively. As a preferred embodiment, raised portions 35 and 36 can be configured within region 37 to properly orient signage 30 on to clip 20 and to reduce the possibility of inadvertent dislodging of the signage from the clip.

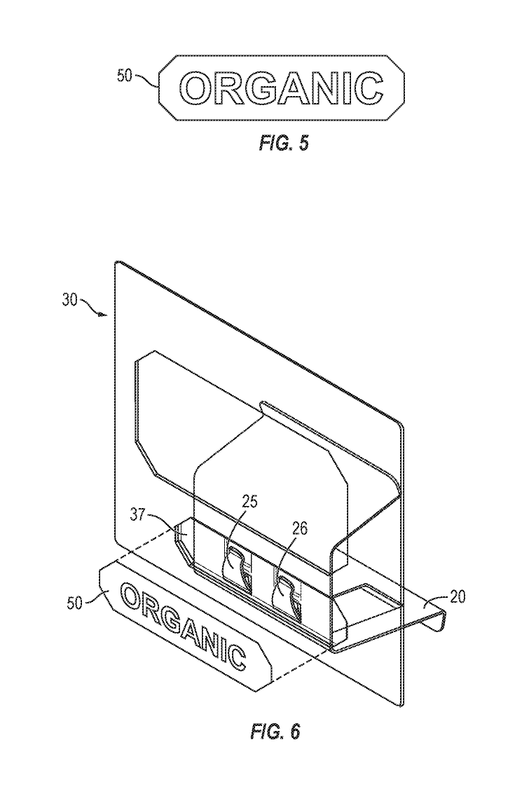

In order to maximize the positive aesthetic presentation that the present invention would have upon consumers, as a further preferred embodiment, secondary signage 50 (FIG. 5) is created to be received within region 37. This not only provides the opportunity to further message consumers (in this case, to tell the consumer that the product being advertised is “Organic”) but also acts to obscure hook members 25 and 26 Preferably, region 37 is sufficiently indented from face 31 such that when secondary signage 50 is placed over region 37 as shown in FIG. 6, it is flush to face 31 creating a visually pleasing sign.

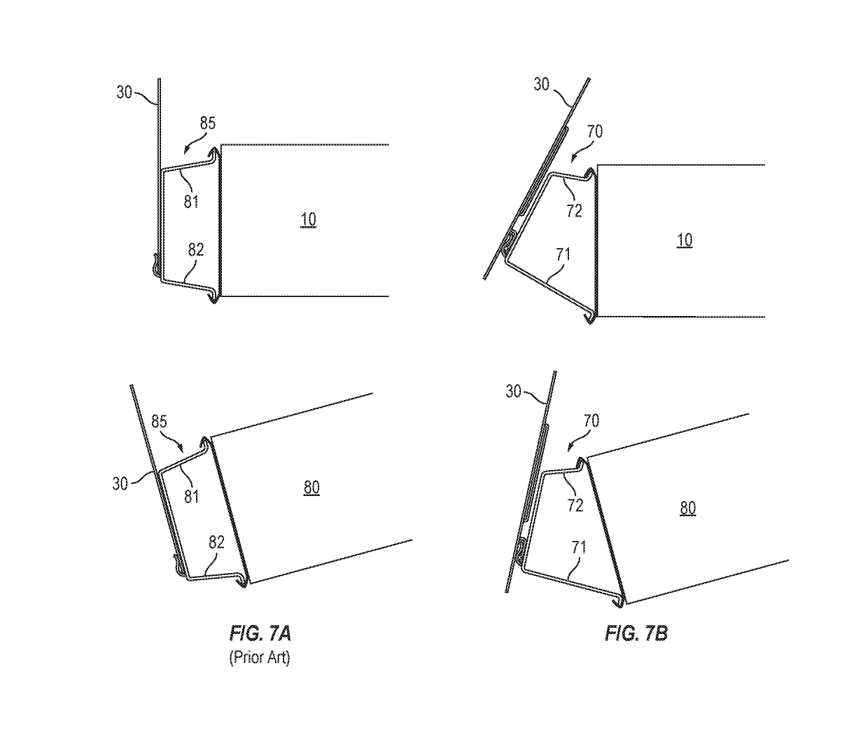

The present invention provides a number of advantages over current signage of the type that is used in the sale of merchandise on shelves having tag molding features Clip 20 allows signage 30 to extend beyond edge 12 of shelf 10 and thus more effectively grab a shopper's attention and provides room at the edge of the shelf for trays and product that often overhangs the shelf edge. In addition, the above-described design of clip 20 causes signage 30 to be oriented diagonally, preferably by about 10°-30°, with respect to the orientation of shelf 10. This can perhaps be best appreciated by making reference to FIGS. 7A and 7B. In turning first to FIG. 7A, horizontally oriented shelf 10, having tag molding channel 13 (as more fully discussed in reference to FIG. 1), receives signage 30 supported by prior art clip 85 As noted, clip 85 is provided with legs 81 and 82 which, as is typically the case, are of equal length. As such, signage 30 is substantially orthogonally oriented with respect to horizontally and diagonally extending shelves 10 and 80 Clearly, as shelf 80 is shown to slant downwardly and as legs 81 and 82 are of equal length, signage 30 would also face diagonally downwardly by an amount dictated by the downward orientation of shelf 80 This can make signage 30 difficult to read by a consumer and thus reduce the overall effectiveness of the display.

By comparison, reference is made to FIG. 7B In each instance, clip 70, again being supported by tag molding at the end of shelves 10 and 80, is characterized by leg 71 being longer than leg 72, resulting in signage 30 oriented diagonally with respect to shelves 10 and 80 As shelf 10 is substantially horizontal, signage 30 would project upwardly with respect to its viewing angle to a consumer while signage 30 would be vastly more readable in instances where shelf 80 tilts downwardly as shown.

The above disclosure is sufficient to enable one of ordinary skill in the art to practice the invention, and provides the best mode of practicing the invention presently contemplated by the inventor. While there is provided herein a full and complete disclosure of the preferred embodiments of the invention, it is not desired to limit the invention to the exact construction, dimensions, relationships, or operations as described Various modifications, alternative constructions, changes and equivalents will readily occur to those skilled in the art and may be employed as suitable without departing from the true spirit and scope of the invention. Such changes might involve alternative materials, components, structural arrangements, sizes, shapes, forms, functions, operational features or the like. Therefore, the above description and illustration should not be considered as limiting the scope of the invention, which is defined by the appended claims

What is claimed is:

1. A system for providing signage associated with a shelf, said system comprising a shelf, such shelf having a forward facing edge, a tag molding channel comprised of channel lips along said forward facing edge, a clip having a forward facing support surface, a first leg extending from said forward facing support surface toward said forward facing edge and having an upturned edge for capture by an upper channel lip and a second leg extending from said forward facing support surface toward said forward facing edge having a downward edge for capture by a lower channel lip, said forward facing support surface being configured to support signage related to goods being supported on said shelf, and wherein said first and second legs are of different lengths such that when said clip is supported by said tag molding channel, said forward facing support surface and associated signage are diagonally oriented with respect to said shelf.

2. The system of claim 1 wherein said first leg is shorter than said second leg such that said support surface and associated signage are diagonally oriented upwardly with respect to said shelf

3. The system of claim 1 wherein said forward facing support surface comprises at least one upwardly extending hook member.

4. The system of claim 3 further comprising signage related to goods being supported on said shelf, said signage having at least one opening for receipt of said at least one upwardly extending hook member

5. The system of claim 4 wherein said at least one opening is positioned within a signage subfield, said system further comprising secondary signage configured to be releasably received by said signage subfield such that, when in place, said secondary signage is positioned to cover said at least one opening and said at least one upwardly extending hook member passing therein

6. A system for providing signage associated with a shelf, said system comprising a shelf, such shelf having a forward facing edge, a tag molding channel comprised of channel lips along said forward facing edge, a clip having a forward facing support surface, a first leg extending from said forward facing support surface toward said forward facing edge and having an upturned edge for capture by an upper channel lip and a second leg extending from said forward facing support surface toward said forward facing edge having a downward edge for capture by a lower channel lip, said forward facing support surface being configured to support signage related to goods being supported on said shelf, and wherein said first and second legs are of different lengths such that when said clip is supported by said tag molding channel, said first leg being shorter than said second leg such that said support surface and associated signage are diagonally oriented with respect to said shelf, said forward facing support surface comprising at least one upwardly extending hook member, said signage having at least one opening for receipt of said at least one upwardly extending hook member, said at least one opening being positioned within a signage subfield, said system further comprising secondary signage configured to be releasably received by said signage subfield such that, when in place, said secondary signage is positioned to cover said at least one opening and said at least one upwardly extending hook member passing therein.
